(19) United States
(12) Patent Application Publication
(10) Pub. No.: US 2007/0239610 A1
(43) Pub. Date: Oct. 11, 2007

(54) METHODS, SYSTEMS AND APPARATUS FOR DISPLAYING USER GENERATED TRACKING INFORMATION

(75) Inventor: Greg M. Lemelson, Southborough, MA (US)

Correspondence Address: ANTOINETTE G. GIUGLIANO, P.C., 100 Cummings Center, Suite 342G, Beverly, MA, 01915, US

(73) Assignee: Floga Holdings, LLC, Southborough, MA (US)

(21) Appl. No.: 11/750,321

(22) Filed: May 17, 2007

(51) Int. Cl. H04L 9/00

(52) U.S. Cl. 705/51

(57) ABSTRACT

The present invention relates to methods, systems, output devices and apparatus for displaying user generated tracking information in an online environment. The method includes tracking one or more actions performed to one or more objects by a user in the environment; determining the amount of time that has passed since the user performed the action to the object; and displaying a tracking display. The tracking display includes user identification, the action performed by the user to the object, reference to or identification of the object, and the measure of time. The amount of time that has passed is updated periodically, to thereby obtain a user generated tracking display.

### BACKGROUND OF THE INVENTION

A user on a website may often wonder about the activity of other users. In social situations, the activity of one person can many times impact the activity of other people. For example, if a professional tennis player buys or uses a particular brand of racket, it induces others who play tennis to buy that brand of racket.

In an online environment, persons are often unaware of activities of other users because such information is not available or displayed, especially in a real-time fashion. For example, a user on a photography website does not know, at any given moment, who is buying a particular type of camera, the skill level of that person (e.g., a professional photographer, a beginner photographer), the purpose for which the camera is purchased, the network that a buyer/user is part of, etc. Although product reviews by peers exist to allow users to post and review others' comments, specific actions of the users on the site cannot be viewed in a real time fashion.

Hence, a need exists to provide an online display having real-time information about the actions of users. A further need exists to provide an online user generated tracking information that includes not only the action of a user, but a user identification, the object to which the action is performed (e.g., purchased a product, or viewed an image), and a measurement of time that has passed since the user performed the action (e.g., 3 minutes and 7 seconds ago) in real time.

### SUMMARY OF THE INVENTION

The present invention relates to methods of displaying user generated tracking information in an online environment. The methods involve displaying a user generated tracking display that includes user identification, an action performed by the user to an object, reference to or identification of the object, and a measure of the amount of time that has passed since the user performed the action to the object. The amount of time that has passed is updated periodically, e.g., to create essentially a real time environment. The methods further include providing the tracking display for one or more users, e.g., a plurality of users. The user identification can include a user login identification, a first name of the user, a last name of the user, a nick name of a user, a user's photograph, a user's tag line, or any combination thereof.

Among the actions that are being tracked and displayed include when a user viewed, posted, uploaded, chatted with, sent an email to, voted on, listened to, purchased, reviewed, commented on, joined in, modified, added to, an object. The actions of users can include any combination of the aforementioned actions. Examples of objects to which actions are performed are text, media (e.g., images, video, audio), a product image, a product webpage, a webpage, a link, a network webpage, and any combination thereof. The methods further include displaying additional user generated information that comprises the user's geographic region, age, sex, hometown, school attended, skill level in a profession, products purchased, networks, friends, and any combination thereof. The user generated tracking display can be sorted by the measure of the amount of time that has passed since the user performed the action to the object (e.g., in reverse chronological order). In an embodiment, the display for each user is ranked by calculating one or more functions, based on one or more variables such as Geographic Region (GR), Age(A), Sex (S), HomeTown (HT), School Attended (SA), Work Place (WP), Previous Work Place (PWP), Skill Level (SL), Media with shared MetaData (MMD), Comments/Review an object (CR), Purchased Product (PP), Shared Friends (SF), Profile Completeness (PC), degree of Social User (SU), Visits to Other Similar sites (VOS), Media Submitted to same Category (MSC), or any combination thereof, to obtain a result for each variable calculated. The method involves summing the results with a weighted formula to thereby obtain a sum, wherein the rank of the user is a function of the sum. The sum is obtained by a weighted formula according to:
Sum=W1(GR)+W2(A)+W3(S)+W4(HT)+W5(SA)+W6(WP)+W7(PWP)+W8(SL)+W9(MMD)+W10(CR)+W11(PP)+W12(SF)+W13(PC)+W14(SU)+W15(VOS)+W16(MSC);
wherein W1, W2, W3, W4, W5, W6, W7, W8, W9, W10, W11, W12, W13, W14, W15 and W16 is a number, wherein the greater the number the greater the weight of the variable, and the lesser the number the lesser the weight of the variable. The tracking display for each user is displayed according to the rank assigned by this algorithm.

In an embodiment, the methods further pertain to tracking one or more actions performed to one or more objects by a user in the environment; determining the amount of time that has passed since the user performed the action to the object; and displaying user identification, the action performed by the user to the object, reference to or identification of the object, and the measure of time that has passed. The online environment can be accessed from a computer, a PDA, mobile phone, or navigation system. The display can further include non-user generated tracking information, and the measure of time is updated periodically as described herein.

In an embodiment, the methods include providing a recommendation to a user that includes a display of one or more users performing similar or the same actions or having similar or the same criteria, in a real time fashion. In particular, the methods further displaying user generated tracking information of user having related data (e.g., matching or similar information and/or actions associated with them). In particular, the methods include tracking one or more actions performed to one or more objects by at least two users in the environment, wherein each user has a profile having one or more pieces of information. The actions and/or pieces of information are compared to determine if the action or pieces of information match to thereby obtain a match. The methods also include determining the amount of time that has passed since the user performed the action to the object; and displaying user identification, the action performed by the user to the object, reference to or identification of the object, said measure of time; and data associated with the match. The amount of time that has passed is updated periodically, to thereby obtain a user generated tracking display.

The present invention also embodies systems and apparatus for providing a user generated tracking display of one or more users. The system or apparatus includes a source of the user generated tracking data of one or more users in an environment for display by a user; a processor, coupled to the source, wherein the processor carries out the steps of the present invention described herein. The systems further include an output device (e.g, a computer, a PDA, mobile phone, or navigation system) that provides the user generated tracking display.

The present invention also includes an output device having an online user generated tracking display of the present invention. The display includes user identification, an action performed by the user to an object, reference to or identification of the object, and a measure of time indicating when the user performed the action to the object. The amount of time that has passed is updated periodically, to thereby obtain a user generated tracking display.

The present invention provides a number of advantages. The present invention allows a user to view activities of other users in real time. The time measurement indicating how much time has passed since the user's action is periodically updated. The user generated tracking display provides a richer, highly social online experience. Additionally, when users unitize the invention using a mobile device, the user generated tracking display can facilitate not only online interaction and behavior, but it can promote offline interactions between users as well. A user having a PDA and looking for a camera obtains a user generated tracking display and finds that professional photographers buy a particular type of camera, and that 10 professional photographers purchase this camera in the last 24 hours. Since PDAs can include information about location of the phone, the non-user generated information included in the display can include information of stores in the vicinity that sell the camera or other users in the area that are selling or using the camera.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a printout of a webpage showing a user generated tracking display having four users, and the display includes a user identification including the user's first name and photograph, the user's hometown and state, the action performed, the object to which the action was performed, a link to the object, the amount of time that has passed since the action was performed, and a link to interact with the user (e.g., view user's images (user's corridor), link to the user's profile, send the user an email, add user as a friend).

FIG. 2 is a printout of a product webpage showing a user generated tracking display having three users, and the display includes a user identification including the user's first name and photograph, the user's hometown and state, the action performed, the object (i.e., the product or product category) to which the action was performed, a link to the object, the amount of time that has passed since the action was performed, and a link to the user's images (user's corridor), a link to the user's profile, a link to send the user a message, a link to send the user an email, and the number of items tracked for the user.

FIG. 3 is a printout of a user's profile webpage showing a user generated tracking display having four users, and the display includes a user identification including the user's first name and photograph, the action performed on the user's webpage (i.e., view), the object (i.e., the profile, the user's images, blog, or vlog) to which the action was performed, a link to the object, the amount of time that has passed since the action was performed, and a link to interact with the user (e.g., view user's images (user's corridor), link to the user's profile, send the user an email, add user as a friend).

FIG. 4 is a block diagram employing the methods of displaying user generated tracking data of the present invention.

### DETAILED DESCRIPTION OF THE INVENTION

The present invention relates to methods of displaying user generated tracking information. A typical tracking display includes tracking information such as user identification (e.g., username, user ID, user photograph or other media such as a video), the object viewed, and a measurement of time indicating when the user displayed or interacted with the object. The time measure is updated periodically and can indicate the amount of time that has passed (e.g., “user viewed this product 13 minutes, 17 seconds ago”). The tracking display can include additional information, both user and non-user generated information. In an embodiment, the tracking display also provides information or recommendations of users having similar or the same tracking information, user-inputted information, and/or information matching or related to certain criteria.

The user generated tracking information that becomes part of the tracking display, in an embodiment, is gathered and/or obtained from a database. User generated tracking information refers to any information or data that is obtained through one or more actions of the user in an online environment. Examples of user generated tracking information include information associated with an object (e.g., media, products, links, or webpages) displayed by or otherwise interacted with the user; one or more time measurements indicating the length of time of any interaction with the object (e.g., viewed this video for 3 minutes, view this page for 10 minutes), actions performed by the user; number of items being tracked for the user, media with shared metadata, number of times the user provided comments/reviews, number and items purchased, number or user identification of shared friends, percentage of profile completeness, amount of activity by user (e.g., number of logins per day, number of media uploads), number visits to similar sites (tracked by a downloaded tool bar), number and type of media submitted to same categories, position of an output device (e.g., GPS location of phone, PDA, computer, navigator) and the like. Tracking data for a user can be obtained from actions performed on one or more websites, on the computer desktop, phone or hand-held device and other output devices. Examples of additional user inputted information includes user profile information such as the user's geographic region, age, sex, hometown, school(s) attended, skill level, e.g., in a profession. User inputted information also includes preferences, criteria or actions for types of users to be included in the display or matched. Both sets of examples include user generated information, however, the difference between the former and the latter is that the former refers to tracked information as generated by the user's actions, and the latter refers to user information inputted by the user. A combination of both types of information, as well as non-user generated information, can be used so long as the tracking display includes one or more (e.g., at least two, three, four, etc.) pieces of user generated tracking information. Non-user generated information can further be included in the display, and examples include product information, links that allow the user to go to other webpages or perform a function (e.g., send an email, add user as a friend in their network, etc.).

An online environment refers to accessing or using the internet, or a global network of computers. An online environment can be accessed from a variety of output devices including a computer, mobile phone, PDA (personal digital assistant), computerized navigation system, media player (ipod, mp3 player) and the like. Output devices include any device that allows for internet access and an output having the user generated tracking display of the present invention. Output devices include those that are known in the art and those that are later developed. The methods of the present invention, in one aspect, is carried out by a processor on a server and displayed on a website. In another embodiment, software can be downloaded to a computer, mobile phone, PDA or other device to carry out the methods described herein. The software can be a desktop application or a tool bar, and can track, store, and communicate the user's action. A tool bar application can be installed as part of the internet browser to track user's actions. The actions of the user can be communicated to a server and stored in a database, and shared with other users. Similarly, tracking information from other users can be transmitted to the user's desktop application to further carry out the steps fo the present invention (e.g., provide a real time tracking display of users). Displaying the tracking display and/or the object refers to a user viewing the tracking display and/or the object, as the case may be, on the output device. A “tracking display” refers to the appearance of user generated tracking information including, but not limited to, reference to one or more actions performed by a user, and reference to the object to which the action was performed along with the time measurement, as described herein. In an embodiment, a display is a series (e.g., plurality) of user generated tracking information for more than one user. Interacting with the object refers to displaying the object and/or information (e.g., tags associated with the object), clicking on the object, listening to the object if an audio file is included, adding or attaching text to an object (e.g., attaching tags to an image or video; adding text to wiki-based article or page). Wiki-based data refer to data built upon a user's input, and preferably built upon multiple users' input. In particular, data entered by the user and attached to a piece of media such as text, an image, a video, or combination thereof, is referred to herein as “metadata” or “metatags.” To display metatags attached to an image, one places the mouse over the image.

An object refers to any online item that can be displayed or interacted with by a user on the output device. Examples of such objects include text, media (e.g., video such as product video or user taken video; images including product images or user taken images; and audio clips), webpages, links, or combinations thereof. An object can be in any format now known or developed in the future. Video includes streaming video, movie files, and any format that includes a series of frames or images. An object can include a file that contains one or more images, video, movie, and/or audio data. Objects can be made up of one or more files that are in any format now known, e.g., jpeg, pdf, tiff, avi, .mov, .mpg, mp3, mp4, .png, gif, psd, and the like or developed in the future. Reference to the object refers to a description of the object, a link to the object, a symbol of the object, or any other way to identify the object. In an embodiment, the object is described (e.g., an image) and a link to the object (e.g., by clicking on the word “image”) is provided, as shown and described herein.

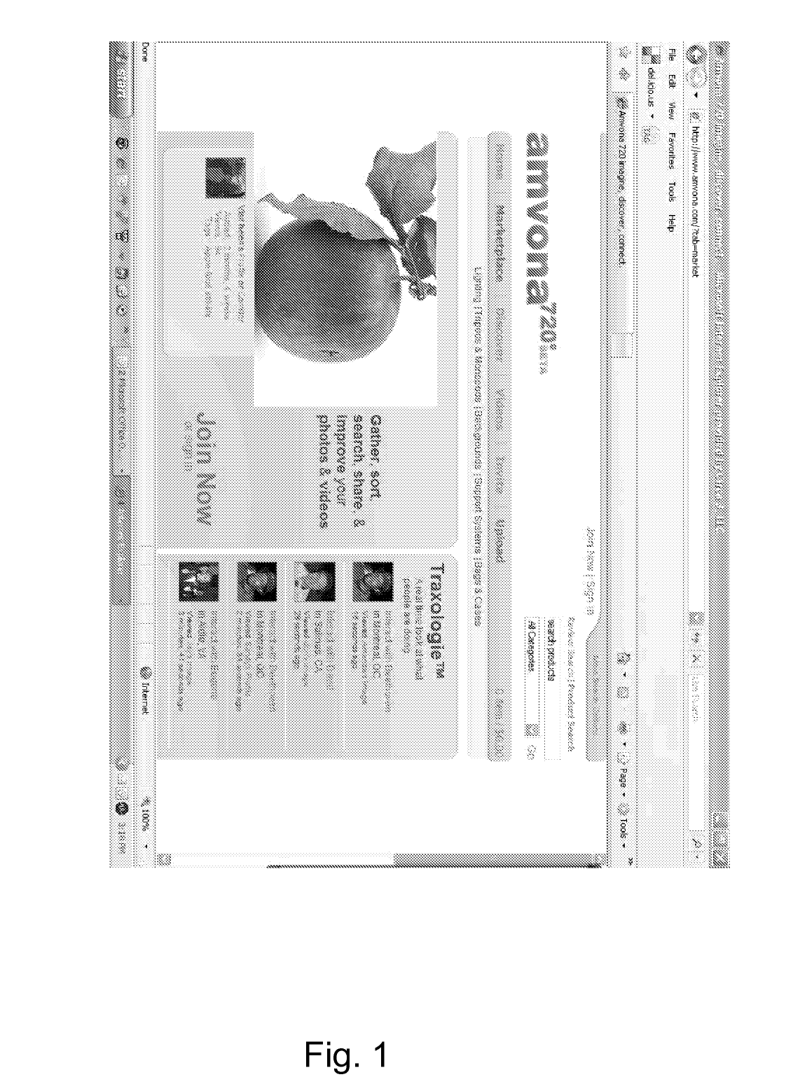

Referring to FIG. 1, the tracking display of user generated data is referred to herein and in the figure as “traxologie.” The Amvona site (www.amvona com) shown in the figure is an integrated social networking and e-commerce site. In an embodiment, the invention is performed in an environment that includes both social networking and e-commerce environments. The environment requests information from the user so the information when the user creates their profile, e.g., user inputted information as described herein, can be displayed in the tracking display. As shown in the tracking display of FIG. 1, the following tracking information is display: user identification, user photograph if available, the location of the user by city and state, the type of interaction performed by the user, the objected with which the interaction took place, and the amount of time that has passed. In FIG. 1, the first user in the traxologie display is Beethoven and is identified by his first name, and his photograph. In an embodiment, the first user in the tracking display can be the user that is logged in and is identified as “You” along with the user's photograph. The user can be identified in many ways and their identification includes their User ID, their name (e.g., first name, last name, nick name), their photograph, their video, tag line, or any combination thereof. The location of the user is Montreal, Quebec. The present invention includes other locations, including home location, work location, current location, location of the output device (e.g., GPS location of their phone, car, PDA, etc.), school location, location where user grew up, location where ancestors are from, or any combination thereof. The location can be conveyed generally, or with greater specificity. Examples, include country, state, county, region, town, street, longitude, and latitude.

The type of action or interaction, shown in FIG. 1, of the first user shown in the tracking display, was a “view,” and the object “viewed” was another user's image. However, the interaction can be any action performed by the user in an online environment. In addition to viewing, user actions that can be included in the tracking display of the present invention include watching a video, listening to an audio file, purchasing a product, reviewing a product, joining a network, adding a comment, adding metadata (e.g., metatags) to an object, uploading media, sending an email, e.g., to a user that is part of the online environment, chatting with another user, voting, joining a network, adding a friend to their network, and the like. The tracking display can contain words, phrases, icons, symbols, or pictures to convey the tracked action by the user. As such, instead of saying “Joe chatted with Kim 4 minutes and 17 seconds ago,” the display can replace the word “chatted” with a symbol of 2 people talking to convey the action.

In addition to the type action the user performs, the object to which the action is performed is also part of the display shown in FIG. 1. As described above, the object can be a product, a user profile, media such as an image or video or a webpage. The objects can be described in the display in any way to convey the nature of the object, and their description includes the use of text, links, a thumbnail of the image/video, icons, a symbol that conveys the object, or any combination thereof. In FIG. 1, the first user viewed a user's photograph, and that is conveyed using the words “Amanda's Image.” The description of the object can have metadata, images, links or any combination thereof associated with it. In this example, when the user places the mouse over the word “Amanda's Image” a thumbnail of the image appears. Text that conveys the object can have tags or images associated with the object to better convey what it is. For instance, if the object was a user profile, then word “profile” can be used, and when the user places the mouse over this word, the user's photograph can appear. Similarly, if the object was a product, a thumbnail form of the product can be display, and when the user places their mouse over the image, the metatags can also appear. Furthermore, the word “product” act as a link to a web page of product information.

Other types of links also form the tracking display shown in FIG. 1. Links to interact with the user exist. In particular, when the current user places their mouse over “Interact with Beethoven”, several links appear. In this example, a link to the user profile appears, along with links to view their uploaded images, to send them an email and to add them to your friends list. Links to any webpage or links that initiate any action can be included as part of the tracking display.

A measurement of time is shown in the tracking display of FIG. 1 indicating the length of time in minutes and seconds that has passed since the interaction. Depending on the activity on the site or by the user, the measurement in of time that has passed can also be measured in days, weeks, months and years as well. A time measurement can be conveyed in a variety of ways to indicate when the interaction took place. In an embodiment, the date and time can be stated in the display instead of a time measurement as a function of the amount of time that has passed. In which case, the display can be periodically updated to reflect actions occurring by users to reflect a real time environment (e.g., by updated the display with users that have recently performed an action to an object). Also the amount of time that has passed can be characterized in words, or symbols, or in general terms such as “today,” “recently,” “a while ago.”

The webpage can be refreshed and updated with the time measurement periodically, e.g., every few seconds, minutes, or hours. In an embodiment, this periodic update provides a real-time environment to make users aware of contemporaneous activity. As defined herein, a real time environment refers to providing information to a user that is close in time to the present moment. To provide a real time environment, the time measurements can be updated at least about every hour, e.g., at least about every 30 minutes, and preferably, at least about every 10 minutes (e.g., about 5 minutes, 3 minutes). In yet another embodiment, the time measurements are provided at least about every 30-60 seconds. Also, in one embodiment, to provide a real-time atmosphere, the time measurements can be updated when another user performs an action, e.g., at a point when a new piece of information is being tracked.

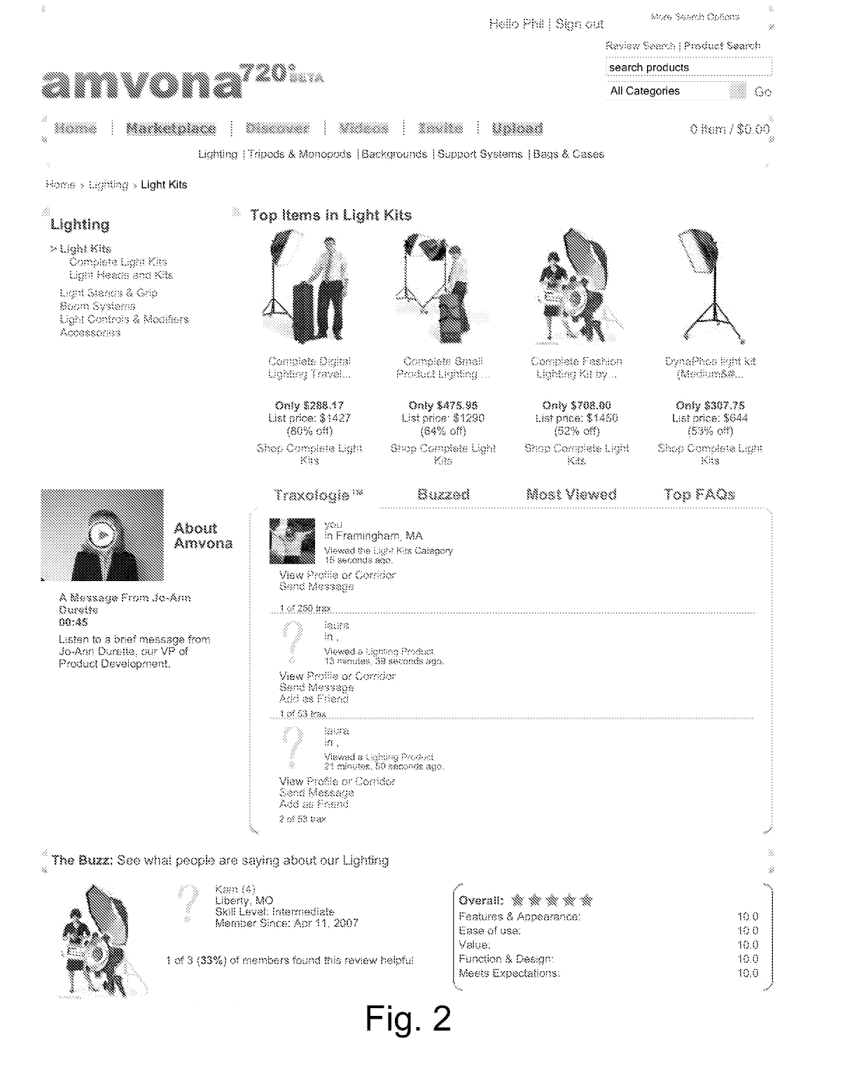

FIG. 2 shows the tracking display of the present invention on a webpage providing information about products sold on the website. This page includes users that have viewed this product page or products in this category. The tracking display is similar to that shown in FIG. 1, but shows only those users that have viewed this product or this product category. As described in FIG. 1, the tracking display comprises a user identification that includes the user's name and photograph, the action tracked, namely that the user viewed, the object, which is the product or product category. Such a product page can also show and indicate users that purchased the product, reviewed or commented on the product, voted for the product, and the like.

One aspect of the invention involves providing a recommendation of a product based. The recommendation can be based on the user's profile, tracking data, as compared to that of other users. For example, if the current user has a number of high resolution images posted under their name, then it can be assumed that they are an avid or expert photographer. As such, the methods involve recommending products such as lighting kits used by other users with a similar quality of photographs. As such, the methods involve comparing the current user generated information with that of user generated data of other users, and if there is a match or similar information, then providing a recommendation (e.g., to purchase the same product of other similar users, to add certain friends to your network of other similar users, view images, etc.).

Another feature shown in FIG. 2, is the number of actions tracked by the online environment. The number of actions performed by the user can be tracked and displayed in the tracking display. FIG. 2 shows that the view of the product by the first user was “1 of 250 trax.” The tracking history for a user, product, or other webpage can form part of the tracking display of the present invention. A link can be provided to the tracking history so that a user can view their history, or another user's tracking history. A display of a user's tracking history can be used along with the object, the type of interaction the object, and a time measurement.

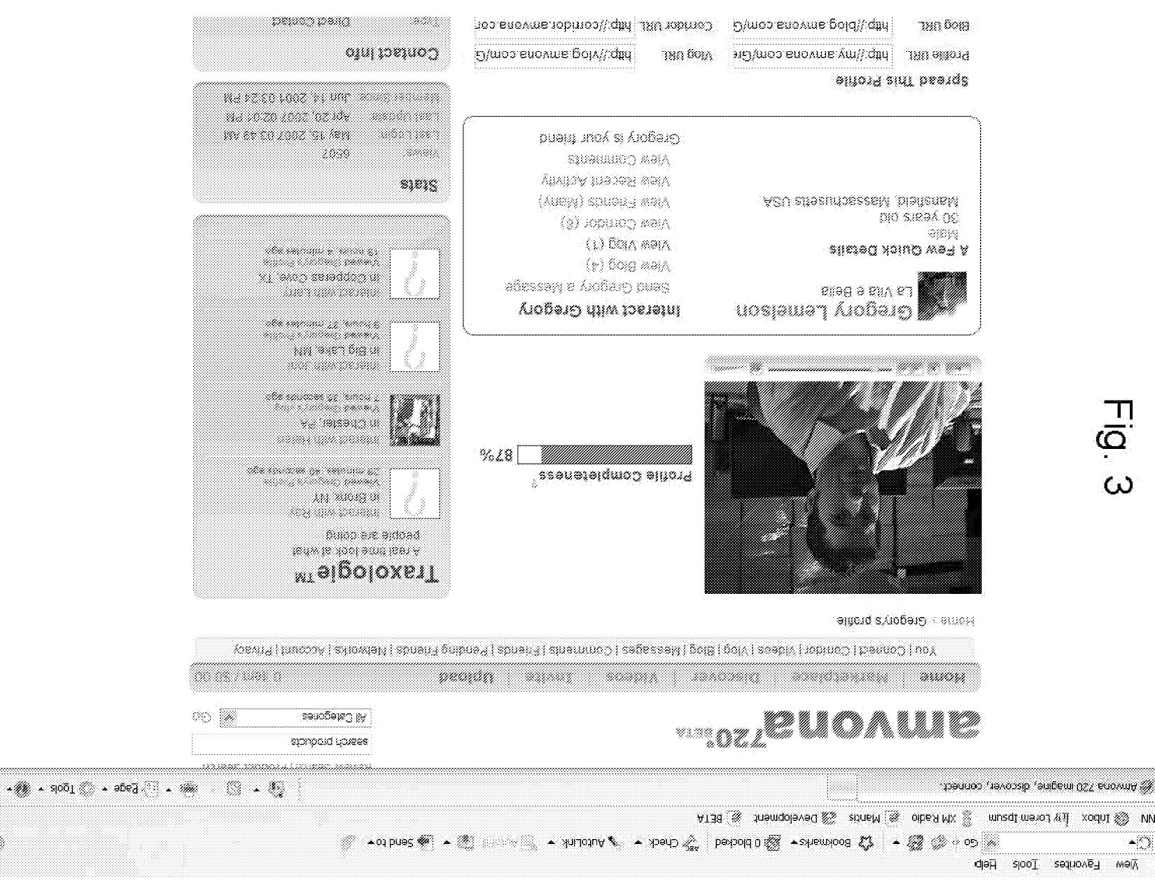

Similarly, FIG. 3 shows the tracking display of the present invention on a user's profile page. Instead of indicating that a product was viewed as in FIG. 2, the tracking display for each user indicates that the profile or a portion thereof was viewed, and how long ago. Other actions typically performed in a social networking profile page include adding the user as a friend, send an email to the user, joining a network of the users, viewing or voting for a posted image by the user, viewing and/or listening to a video file posted by the user, etc.

The methods described herein utilize a graphical user interface (GUI), or an interface known in the art, or later developed. Software that can be used to create, in part or in whole, such an interface and perform the steps described herein includes, e.g., AJAX (Asynchronous Java and XML) software, Adobeflex, DreamWeaver, and FLASH software, javascript, php, css, asp, cold fusion, jsp ruby, ruby on rails, and the like. An interface refers to any mechanism by which an external user via a computer, media player, mobile phone, PDA, navigation system can obtain and provide data described herein.

In an embodiment, the methods include providing a display with one or more recommended users, products, or actions in response to user generated or user inputted data of the current user. The recommendation can be based on the user's actions in either an e-commerce environment, a social networking environment, or a combination thereof. For example, if the user is on a webpage that describes a photography light kit, then the methods include a display with other users who recently purchased or viewed that or similar light kit. In another example, the methods can recommend or place certain users in the current user's display based on information in the user's profile. For example, if the user has indicated that they are from Boston, Mass., then the display can rank users according to their location, as compared reverse chronological order. In yet another example, the methods can recommend other users to be the current user's “friend” or recommend that the user join the current user's network based on similar profile attributes, friends in common, similar media posted, and the like. As such, the methods include providing recommendations of other users, products or action, based on the user generated tracking information of the current user and that of other users. The methods further include display such recommendations along with the information of the tracking display e.g., displaying user identification, an action performed by the user to an object, reference to or identification of the object, and a measure of time indicating when the user performed the action to the object. In fact, algorithms, like that described below, can rank users according to certain variables, according to a pre-determined algorithm, or one customized, in whole or in part, by the current user.

In such a case, the methods include providing a recommendation to the current user in a real time fashion. The methods make recommendations, and/or include other users in the display that are related. “Related” users refers to users that performed similar or the same actions or having similar or the same criteria inputted by the user. Similar actions refer to actions that may not be identical, but close to that performed by the user. For example, if the current user is viewing a webpage on lighting kits, the methods can include in the display, users that bought another lighting kit or a item in that category. The display includes or recommends information relating to users performing: 1) the same actions on the same object/product/webpage; 2) the same actions for different object/product/webpage, and 3) a different action on the same object/product/webpage.

The actions and the objects to which the actions are performed of the current user are compared to that of others, and if there is match or correlation between the action and/or the objects, then the user, in an embodiment, is assigned a weight for the tracking display. The methods also include, in one aspect, determining the amount of time that has passed since the user performed the action to the object; and displaying user identification, the action performed by the user to the object, reference to or identification of the object, said measure of time; and data associated with the match.

In one embodiment, the tracking display is sorted in the figures in reverse chronological order, with the lasted action displayed first. In another embodiment, the order in which the user's tracking information can be generated using a weighted algorithm. Users, along with their tracking information, can be ranked (Traxologie Rank (TR)), in an embodiment, according to the following tracking algorithm:
TR=W1(GR)+W2(A)+W3(S)+W4(HT)+W5(SA)+W6(WP)+W7(PWP)+W8(SL)+W9(MMD)+W10(CR)+W11(PP)+W12(SF)+W13(PC)+W14(SU)+W15(VOS)+W16(MSC)
wherein parameters W1-W16 are numbers that assign a weight (e.g., a number) to each variable, and the weight assigned can vary as desired based on their importance to the site utilizing algorithm. In an embodiment the weighted number ranges from 0.1-99. For example, if the site utilizing the algorithm values one variable over another, then a weight can be assigned accordingly. The greater the number, the greater the weight that is assigned to the variable, and the lesser the number the lesser is the weight of the variable. In an embodiment, the weights were assigned as follows: W1=30, W2=7, W3=8, W4=0.25, W5=2, W6=0.1, W7=20, W8=0.7, W9=0.3, W10=5, W11=6, W12=20, W13=1, W14=0.8, W15=2.5, W16=0.7. These weights can range in an amount between about 1 to about 99. However, if the site using the algorithm values a one variable more than another, then the user can assign a greater weight to one, e.g., 30 than the other, e.g., 2.

In an embodiment, the user assigns weight to these variables so that users that meet or are closer to these criteria are displayed first or higher on the list of users. In such an embodiment, rather than assigning a specific number, the user can indicate the emphasis to be placed on the particular variable using a qualitative input (e.g., using a slide bar; indicating high, medium, low; and the like). A qualitative input can be translated to a quantitative amount or weight, by comparing the possible choices to one another and assigning a value. For example, if a user indicates that she places a “high” importance of viewing users of a similar age, then a 50 can be assigned to that variable, whereas an indication of “low” for home town can be assigned a 0.2 value. The variables, in an embodiment, are defined as follows:

GR (Geographic Region)=2 if one lives in the same city with the user, 1 if one lives in the same state with the user, or 0 otherwise.

A (Age)=5 if the user is within 5 years of age, a 3 if the user is within 7 years of age, and a 1 if within 10 years of age, otherwise 0;

S (Sex)=2 if opposite sex, otherwise 0;

HT (Home Town)=5 if same home town; 3 if home time is within 100 miles of user; otherwise zero;

SA (School Attended)=10 if same school attended at the same time; 5 if same school at different times, otherwise 0;

WP (work place)=3 if same work place, otherwise 0;

PWP (Previous Work Place)=1 if same previous work place, otherwise 0;

SL (Skill Level)=8 if same skill level, 5 if skill level is close to user; otherwise 0;

MMD (Media with shared MetaData)=+0.3*log(# of tags+1)+0.1*log(size of the photo file in Mega bytes+1);

CR (Comments/Review an object)=log(# of comments+1);

PP (Purchased a Product)=3 if user purchased product on website, otherwise 0;

SF (Shared Friends)=shared user/friend (1 if user is a friend, 0 otherwise)+0 otherwise);

PC (Profile Completeness)=percentage of profile complete×0.01.

SU (degree of Social User)=log((#of login)+# of clicks+# of interactions with other users (e.g., view profile, send message) over a period of time+1);

VOS (Visits to other similar sites)=log(# of clicks on similar sites+1);

MSC (Media Submitted to same Category)=1 if same category, otherwise 0.

These variables, when applicable, are compared to the user. For example, the school attended of other users that could be in the tracking display is compared to the current user and assigned a weight, as indicated. These variables can be calculated in other ways, or can be modified yet incorporate the essence of the variable. One or any combination of these variables can be used. Additional variables can be added to rank the users in the display. The user can customize these variables so that certain types of users are displayed. In one embodiment, the user can indicate that she prefers men within 5 years of her age to be displayed. In another embodiment, the user can indicate that she prefers females that live in her city to be displayed.

In such a case, the methods involve comparing data inputted by the current user with user generated or user inputted information of other users, and displaying the users that match the criteria, or that are similar to the criteria. In particular, users with matching or similar criteria are ranked higher than those with dis-similar or non-matching criteria. Higher ranking users are displayed before lower ranking users. A particular embodiment includes a display with an indication or recommendation that one or more user matches the preferred criteria. The methods include providing a recommendation of one or more users that most closely matches the preferred criteria.

In application, on a product page for photography equipment, the tracking display of the present invention can rank users who have higher skill levels, and those who updated more, high quality images (e.g., more pixels), higher than those who do not. As such, a skill level designated as “expert,” as compared to “beginner” will be assigned a higher weight. Accordingly, rather than sorting user tracking data in reverse chronological order, users are sorted by skill level and image upload. Other example that can be assigned a higher weight is the quality and amount of professional photography equipment purchased by the user, the type of networks to which the user is a part (e.g., a professional photography group), the number of other professional or expert skill level photographers that are part of the user's network, etc.

These variables are a function of one or more data elements (e.g., data used to compute the function). For example, Geographic (G) region or HT (Home Town) of users, as compared to the current user, impacts the rank of the users in the display. In an embodiment, the algorithm gives more weight to the user that live or grew up in the same city, as compared to an intermediate weight in the case in which the user live in the same state. No weight is given otherwise. The G or HT algorithm can be varied for any type of geographical categories, including, for example, by neighborhood, city, county, area, state, regions of a country, country, and continent. Location can also be meant to include type of terrain, such as a beach, mountains, suburbs, city, rural, etc. The variable can also be used to give weight to users living within a certain number of miles of the poster of the media (e.g., 1, 5, 10, 15, . . . 100 miles, etc.). This variable utilizes any function of associating the current user's location with that of other users and is encompassed by the methods described herein.

The Age variable is used, in an embodiment, to assign a weight to the user in the display of the present invention. The age can be characterized by a specific age (e.g., 35 years old), a age range (e.g, 25-35 years), an age +/− a certain number of years (e.g., +/−3 years), or age description (e.g., young, old, retired, generation X, etc.).

Sex refers to the gender of the user. The user can indicate whether the user prefers to view male or female users in the display of the present invention. The preferred gender is awarded greater weight to the non-preferred gender.

Skill level (SL) refers to a variable that indicates whether the user prefers a display having a particular skill level in a profession. For example, on the Amvona website shown in the figures, the website sells photography equipment, and therefor attracts professional photographers. As such, a user or the algorithm can provide a higher weigh to “expert” skill levels, as compared to a “beginner”. Skill levels can be for any field, and can be used for one or more fields of work. Skill levels can be represented as expert, skilled, beginner, or in an fashion to convey the competency of a user in a particular field. The skill level can also be represented numerically, e.g., on a scale from 1 to 10. The skill level is converted to a weight and used in the algorithm. As with all variables, the calculation of the weights can be varied either depending on the user's preference or the preference of the website.

Variables relating to the user's SA (School Attended), WP (work place), or PWP (Previous Work Place), in an embodiment, are used to influence an overall rank of a user in the display or methods of the present invention. School attended includes preschool, elementary, middle school, high school, college, post graduate schools, and any other teaching institution. Work place refers to specific companies, affiliates or parents of companies, and types of companies/employment. If the school attended, workplace or previous work place are the match that of the current user, the user receives a higher weight than a user without any of these three matches. School attended can also be coupled with the dates attended to provide a higher weight. Overlap of the dates attended can provide an overall higher weight than no overlap. The work place or school attended can include the specific school/workplace, the type of school/workplace, affiliated schools/workplaces, etc. These variables can be modified to be general or specific to cast either a larger pool or smaller pool of users, depending on the number of users on the site.

Media with shared MetaData (MMD) and Comments variables give users who upload images with metatags and/or users that provide comments on images or products a higher weight, as compared to users that do not. Generally users that often upload media and take the time to attach metatags, or make comments are more sophisticated users, and in an embodiment, can be afforded a greater weight. In particular, this variable is based on the number of user generated comments, the number of metadata (e.g., metatags) and the size of the media file. The size of the file relates to the quality of the file. A larger file size correlates with the assumption that the media is of a better quality, than a smaller file. This media variable, in an embodiment, can contain any combination of the number of comments, the number of metadata sets, and file size when executing the discovery algorithm. Also, media submitted by a user to the same category (MSC) of the current user can also be a variable in the algorithm. In an embodiment, users that submit media to same category receives a higher rank than users that have not provided media to the same category.

The Shared Friends or Friend boost relates to the social network to which the user belongs, and the permission users of the network provide. This variable is a function of whether the user to be displayed is identified as a “friend” or in the network of the current user. This function is also influenced by whether the user has permission by the user to view the user's profile and associated photographs. Being part of the user's network, being identified as a friend, and being given permission to view the user's profile increases the weight assigned to the user. Conversely, the absence of any of these elements of the variable decreases the overall weight assigned to the media. Any combination of these elements can be used in the Friend Boost variable of the present invention.

Similarly, the degree of the Social User (SU) variable, in an aspect, is a function of the number logins, number of friends, number of contacts or interactions with other users, and/or the number of media uploads in a specific period. The higher number of logins, friends in the network are indications of highly social users. Also the number of media uploads contributes to an increase in the degree of social interaction of the user, since media often increases the number of hits, friends and interactions the user receives. As such, users with a higher degree of social networking interaction is accorded a higher weight than a user that does not have a large social network. Other elements that can be included in the degree of the social user is the number of friends in their friends' network. Any element that indicates the degree of the user interacts with other users can be used to assign a weight to this variable. Similarly, users that visit to similar websites can also receive a higher weight than those who do not. For example, users that visit other social networking sites, or sites that sell similar goods can be recorded or tracked. The tracking of this information allows it to be analyzed and, the user accorded a weight accordingly.

Yet another variable that can be used to impact a user's weight relates to whether the user purchased a product on the website. In an environment in which e-commerce and social networking is involved, including users that purchase products can be helpful to the current user, especially if the current user is interested in purchasing a product as well. In the case in which the current user can modify their preference, the user who wants to purchase a product can increase the weight assigned to users that have purchase a product. As such, the current user will obtain a display having users that have purchased one or more products ranked higher. Additionally, users that have purchased more products can be assigned a higher weight than those that have purchased fewer products. The algorithm that assigns weight to this variable can be modified accordingly.

The Percentage of a user's Profile completed also can be involved in assigning a rank to a user in the display of the present invention. Users with a higher percentage of their profile completed, in one aspect, receive a higher weight than those who have a lower percentage of the profile completed. The more information that a user provides to complete their profile allows more information against which to compare. The social network and the methods of the present invention is more robust when users have a greater amount of their profile completed. As such, in an embodiment, the percentage of completeness of a user's profile is given a greater weight.

In an embodiment, the tracking algorithm of the present invention uses any combination of these user generated variables so long as at least one or more user generated variable is used. A user or implementor of the website can assign greater or lessor weights than those described herein, depending on which variables are more important to the user, as desired. In the case in which a variable is removed from the algorithm, the weighted algorithm would delete the weight relating to that variable, and assign the remaining variables greater weight, as desired. Any combination of these variables can be used, and each variable can be modified by using suitable or similar substitutes. Moreover, any element or user generated/inputted data can be used in such variables of the tracking algorithm. Furthermore, elements can be substituted or modified (e.g., use some or additional elements of the variable) so long as the overall spirit of the variable is maintained. Hence, using this algorithm, the order in which the user's tracking information is displayed can be determined by the weight or rank assigned.

The present invention relates to a tracking display, a system or computer apparatus for ranking and/or providing a display of user generated tracking information. The tracking display output includes one or more user generated tracking data, as described herein. The system includes a source of the user generated tracking data and objects to which they are associated. A processor which is coupled to the source, calculates one or more functions in accordance with the methods described herein, and/or sums the results of the functions according to the weighted formula. An output device (e.g., a monitor, a printer, PDA, mobile phone, media player, navigation system and the like) provides the user a display of the tracking information, and optionally according to the rank which reflects the sum obtained with the processor.

User generated tracking data is tracked or obtained by recording actions by users. Actions by the users, along with other necessary data, as described herein, including the object with which they interacted, the functions that they performed, metatags that they added to the object, are stored as data that is provided to a library, index or database.

The present invention encompasses methods for providing or storing user generated tracking data to a database. The database is a collection of two or more pieces of stored data. Data can be stored in a manner, and in a mode known in the art, or developed in the future. Examples of types of databases that store user generated metadata and links include MY SQL, SQL, and Oracle. The data being stored, whether physically together, or associated with one another, includes the user generated data, user generated tracking data, user inputted data, and/or information about the object to which user action is performed. In addition to providing and/or storing user generated tracking data collected, the methods of the present invention also include associating the user inputted data with other types of data including user-specific data (e.g., name, address, email, preferences) about themselves, or product/service specific data, e.g., provided by an e-commerce company.

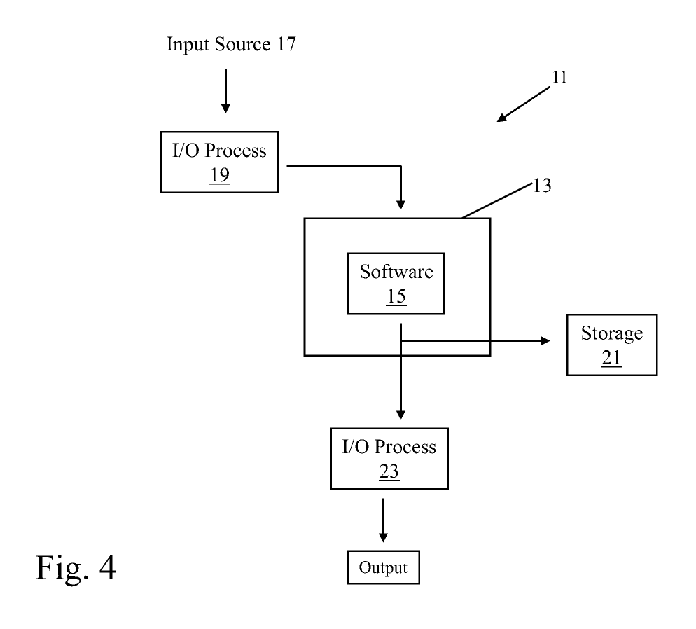

The database can be connected to or form part of the computer system employing a network of computers. Referring to the output, the tracking display obtained using the methods described herein can be displayed, e.g., on a screen in the order of their ranking or in reverse chronological order. As shown in FIG. 4, a computer system embodying a software program 15 (e.g., a processor routine) of the present invention is generally shown at computer system 11. The computer network includes a server to communication the tracking display to various output devices. The server can communicate with individual computers, PDAs, cell phones, ipods, and any other output device capable of showing or communicating the display of the present invention. The computer system 11 employs a host processor 13 in which the operation of software programs 15 are executed (e.g., a program that allows for the steps of the methods described herein to be carried out). An input device or source such as on-line data or a database of stored user-inputted data and the like provides input to the computer system 11 at 17. The input can be pre-processed by I/O processor 19 which queues and/or formats the input data, if necessary, as needed. The user inputted data is then transmitted to host processor 13 which processes the data through software 15. Using the input data, software 15 provides an output for either memory storage 21 or display through an I/O device, e.g., a work-station display monitor, a printer, and the like. I/O processing (e.g., formatting) of the content is provided at 23 using techniques common in the art.

In addition to have a computer system employing a host processor on a server to execute the steps of the present invention, the software can be downloaded to user's computer, PDA, ipod or other device to obtain user generated or user inputted information. The software can track their actions and communicate the data to a server. The server can process the information and provide it to other users, and provide the tracking display of other users, and/or recommendations of users, as described herein. The software can be in a form of a desktop application, or as a tool bar.

This application relates to U.S. application Ser. No. 11/674,527, filed Feb. 13, 2007, entitled, “Methods and Systems for Displaying Media Utilizing User-generated Data” by Greg M. Lemelson.

This application is relates to U.S. application Ser. No. 11/674,516, filed Feb. 13, 2007, entitled, “Social Networking and E-commerce Integration” by Greg M. Lemelson.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of displaying user generated tracking information in an online environment, the method comprises:
displaying user identification, an action performed by the user to an object, reference to or identification of the object, and a measure of time indicating when the user performed the action to said object;
to thereby obtain a user generated tracking display, wherein the display is updated periodically.

2. The method of claim 1, further including providing said user generated tracking display for more than one user.

3. The method of claim 2, wherein displaying user identification comprises displaying a user login identification, a first name of the user, a last name of the user, a nick name of a user, a user's photograph, a user's tag line, or any combination thereof.

4. The method of claim 3, wherein displaying the action includes displaying when the user viewed, posted, uploaded, chatted with, sent and email to, voted on, listened to, purchased, reviewed, commented on, joined in, modified, added to, an object, or any combination thereof.

5. The method of claim 4, wherein the object includes text, media, a product image, a product webpage, a webpage, a link, a network, and any combination thereof.

6. The method of claim 2, further including displaying additional user generated information that comprises the user's geographic region, age, sex, home town, school attended, skill level in a profession, products purchased, networks, friends, and any combination thereof.

7. The method of claim 1, wherein the display is sorted by the measure of the amount of time that has passed since the user performed the action to said object.

8. The method of claim 1, wherein the tracking display includes more than one user, and the method includes displaying user generated tracking information for each user according the a rank assigned using a method that comprises:
a. calculating one or more functions, based one or more variables based on Geographic Region (GR), Age(A), Sex (S), Home Town (HT), School Attended (SA), Work Place (WP), Previous Work Place(PWP), Skill Level (SL), Media with shared MetaData (MMD), Comments/Review an object (CR), Purchased Product (PP), Shared Friends (SF), Profile Completeness (PC), degree of Social User (SU), Visits to Other Similar sites (VOS), Media Submitted to same Category (MSC), or any combination thereof, to obtain a result for each variable calculated; and
b. summing said one or more results with a weighted formula to thereby obtain a sum;
wherein the rank of the user is a function of the sum.

9. The method of claim 8, wherein the sum is obtained by a weighted formula that comprises:
Sum=W1(GR)+W2(A)+W3(S)+W4(HT)+W5(SA)+W6(WP)+W7(PWP)+W8(SL)+W9(MMD)+W10(CR)+W11(PP)+W12(SF)+W13(PC)+W14(SU)+W15(VOS)+W16(MSC);
wherein W1, W2, W3, W4, W5, W6, W7, W8, W9, W10, W11, W12, W13, W14, W15 and W16 is a number, wherein the greater the number the greater the weight of the variable, and the lesser the number the lesser the weight of the variable.

10. A method of displaying user generated tracking information in an online environment, the method comprises:
a. determining the amount of time that has passed since a user performed an action to an object; and
b. displaying user identification, an action performed by the user to an object, reference to or identification of the object, and said measure of time;
wherein the amount of time that has passed is updated periodically, to thereby obtain a user generated tracking display, wherein the online environment is accessed from a computer, a PDA, mobile phone, or navigation system.

11. The method of claim 10, further including displaying non-user generated tracking information.

12. A method of displaying user generated tracking information in an online environment, the method comprises:
a. tracking one or more actions performed to one or more objects by a user in the environment;
b. determining the amount of time that has passed since the user performed the action to the object; and
c. displaying user identification, the action performed by the user to the object, reference to or identification of the object, and said measure of time;
wherein the amount of time that has passed is updated periodically, to thereby obtain a user generated tracking display.

13. A method of displaying user generated tracking information in an online environment, the method comprises:
a. tracking one or more actions performed to one or more objects by at least two users in the environment, wherein each user has a profile having one or more pieces of information;
b. comparing actions, pieces of information or both of the users to determine if the action or pieces of information are related;
c. determining the amount of time that has passed since the user performed the action to the object; and
d. displaying related user identification, the action performed by the user to the object, reference to or identification of the object, and said measure of time;
wherein the amount of time that has passed is updated periodically, to thereby obtain a user generated tracking display.

14. The method of claim 13, wherein the display further includes the user's name, user identification, actions performed, information associated with the user's profile and any combination thereof.

15. A system for providing a user generated tracking display of one or more users, the system comprises:
a. a source of the user generated tracking data of one or more users in an environment for display by a user;
b. a processor, coupled to the source, wherein the processor carries out the steps that comprise:
i. displaying user identification, an action performed by the user to an object, reference to or identification of the object, and a measure of the amount of time that has passed since the user performed the action to said object; wherein the amount of time that has passed is updated periodically, to thereby obtain a user generated tracking display; and
c. an output device that provides the user generated tracking display.

16. The system of claim 15, wherein the output device is a computer, a PDA, mobile phone, or navigation system.

17. A system for providing a user generated tracking display of one or more users, the system comprises;
a. a source of the user generated tracking data of more than one user in an environment for display by a user;
b. a processor, coupled to the source, wherein the processor carries out a methods that comprises:
i. tracking one or more actions performed to one or more objects by a user in the environment;
ii. determining the amount of time that has passed since the user performed the action to the object;
iii. ranking user generated tracking data for each user, comprising the steps of:
(1) calculating one or more functions, based one or more variables based on Geographic Region (GR), Age(A), Sex (S), Home Town (HT), School Attended (SA), Work Place (WP), Previous Work Place(PWP), Skill Level (SL), Media with shared MetaData (MMD), Comments/Review an object (CR), Purchased Product (PP), Shared Friends (SF), Profile Completeness (PC), degree of Social User (SU), Visits to Other Similar sites (VOS), Media Submitted to same Category (MSC), or any combination thereof, to obtain a result for each variable calculated; and
(2) summing said one or more results with a weighted formula to thereby obtain a sum;
wherein the rank of the user is a function of the sum; and
iv. displaying user generated tracking data according to rank, wherein the display comprises user identification, the action performed by the user to the object, reference to or identification of the object, and said measure of time; wherein the amount of time that has passed is updated periodically, to thereby obtain a user generated tracking display;
c. an output device that provides the user generated tracking display according to said rank.

18. The system of claim 17, wherein the processor calculates the sum using a weighted formula that comprises:
Sum=W1(GR)+W2(A)+W3(S)+W4(HT)+W5(SA)+W6(WP)+W7(PWP)+W8(SL)+W9(MMD)+W10(CR)+W11(PP)+W12(SF)+W13(PC)+W14(SU)+W15(VOS)+W16(MSC);
wherein W1, W2, W3, W4, W5, W6, W7, W8, W9, W10, W11, W12, W13, W14, W15 and W16 is a number, wherein the greater the number the greater the weight of the variable, and the lesser the number the lesser the weight of the variable.

19. An output device having an online user generated tracking display that comprises
a. user identification, an action performed by the user to an object,
b. reference to or identification of the object, and
c. a measure of time indicating when the user performed the action to said object;
wherein the amount of time that has passed is updated periodically, to thereby obtain a user generated tracking display.

20. The output device of claim 19, wherein the output device includes a computer, a PDA, mobile phone, or navigation system.
